(19) United States
(12) Patent Application Publication
(10) Pub. No.: US 2006/0077285 A1
(43) Pub. Date: Apr. 13, 2006

(54) Monitoring camera with a shade

(76) Inventor: Yi-Jen Cheng, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/962,324

(22) Filed: Oct. 8, 2004

(51) Int. Cl. G03B 15/02; H04N 5/225; G03B 17/00; G03B 17/02

(52) U.S. Cl. 348/373; 396/427; 396/535; D16/203

(57) ABSTRACT

A monitoring camera with a shade consists a camera body, a shade, at least two engaging elements, and at least two locking elements respectively corresponding to the at least two engaging elements in quantity. The shade has an inner surface and two tracks formed on the inner surface. The engaging elements are attached to the camera body to engage with the tracks on the shade. Because the engaging elements protrude from the camera body and are obviously visible, alignments of the engaging elements to the tracks are performed easily. Moreover, the locking elements further penetrate the shade to correspondingly combine with the engaging elements so as to firmly secure the shade on the monitoring camera.

### BACKGROUND OF THE INVENTION

1. Field of the Invention

The present invention relates to a monitoring camera, and more particularly to a monitoring camera with a shade wherein the shade is mountable on the monitoring camera easily and firmly.

2. Description of Related Art

With reference to FIGS. 5 and 6, a conventional configuration of a camera body (50) and a shade (60) detachably mounted on the camera body (50) is shown. The camera body (50) is cylindrical and has an outer periphery and two pairs of longitudinal grooves (52) respectively defined on two opposite sides of the outer periphery. The shade (60) is a U-shaped casing and mounts on the camera body (50) to partially cover the camera body (50). The shade (60) has two distal edges, an inner surface and two pairs of ribs (62) respectively formed on the two distal edges. When the shade (60) combines with the camera body (50), the two pairs of ribs (62) must correspondingly align to and engage with the two pairs of longitudinal grooves. However, aligning the multiple ribs (62) and grooves (52) at the same time is not easy so that combination of the shade and monitoring camera is time-consuming. Moreover, the grooves (52) formed on the outer periphery of the camera body (50) are shallow and the ribs (62) easily slide out of the grooves (52) so that the shade (62) easily loosens and separates from the camera body (50).

The present invention has arisen to mitigate or obviate the disadvantages of the conventional shade for a monitoring camera.

### SUMMARY OF THE INVENTION

The main objective of the present invention is to provide a monitoring camera with a shade, which can be assembled quickly and easily.

Another main objective of the present invention is to provide a monitoring camera with a shade, which has a firm configuration.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a monitoring camera with a shade in accordance with the present invention;

FIG. 2 is a partially exploded view of an engaging element used in the monitoring camera in FIG. 1;

FIG. 3 is a cross-sectional top plane view of the monitoring camera with a shade in FIG. 2;

FIG. 4 is a perspective view of another embodiment of the monitoring camera with a shade in accordance with the present invention;

FIG. 5 is a front plane view in partial cross-section of a conventional monitoring camera with a shade in accordance with prior art; and

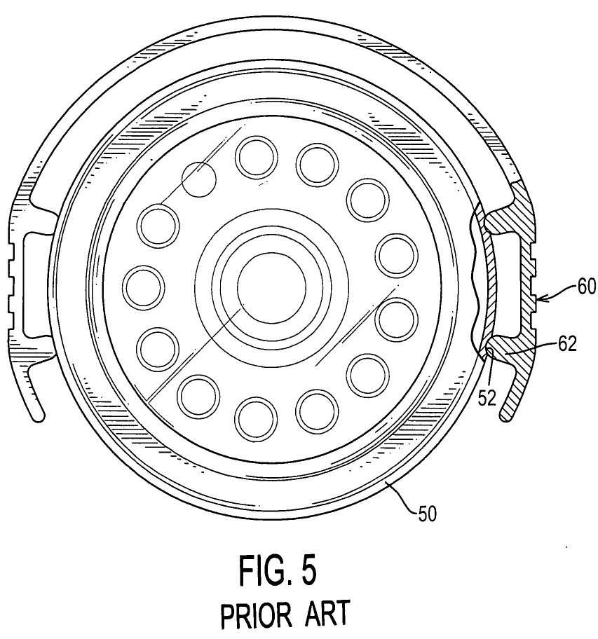

FIG. 6 is a cross-sectional side view of a partial section of the conventional monitoring camera with a shade.

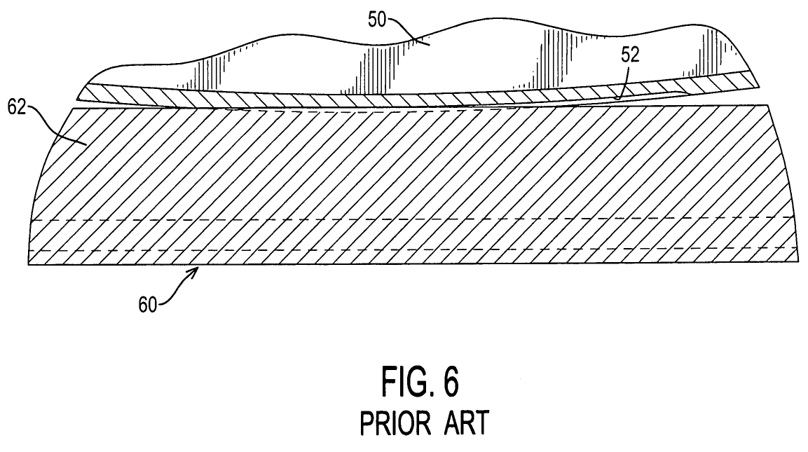

### DETAILED DESCRIPTION OF THE PREFERRED EMBODIMENT

A monitoring camera with a shade in accordance with the present invention comprises a camera body, a shade, at least two engaging elements, and at least two optional locking elements respectively corresponding to the at least two engaging elements. The shade has an inner surface and two tracks formed on the inner surface. The engaging elements are attached to the camera body to engage with the tracks on the shade. Because the engaging elements protrude from the camera body and are obviously seen, alignments of the engaging elements to the tracks are done easily. Moreover, the locking elements further penetrate the shade to correspondingly combine with the engaging elements so as to secure the shade on the monitoring camera.

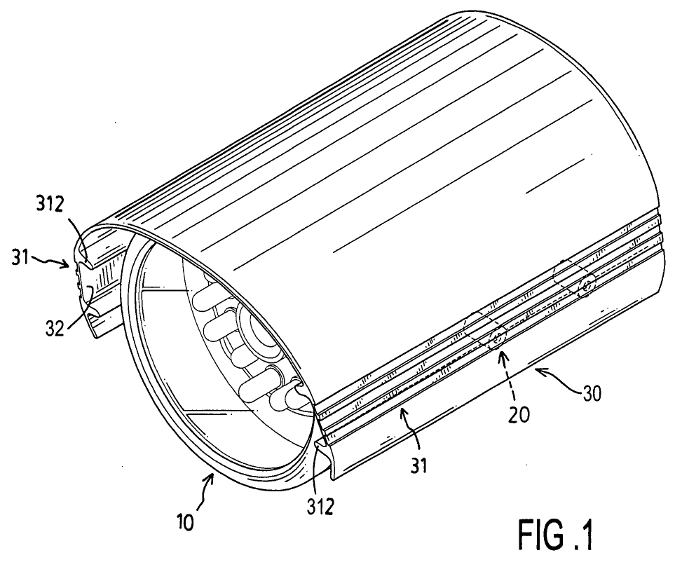

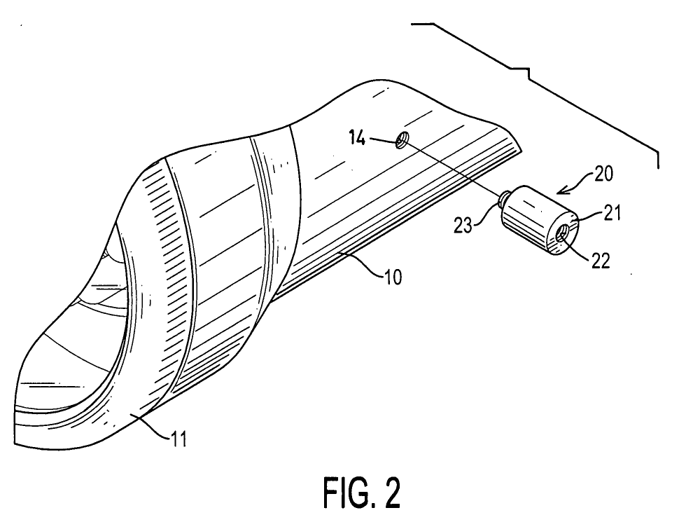

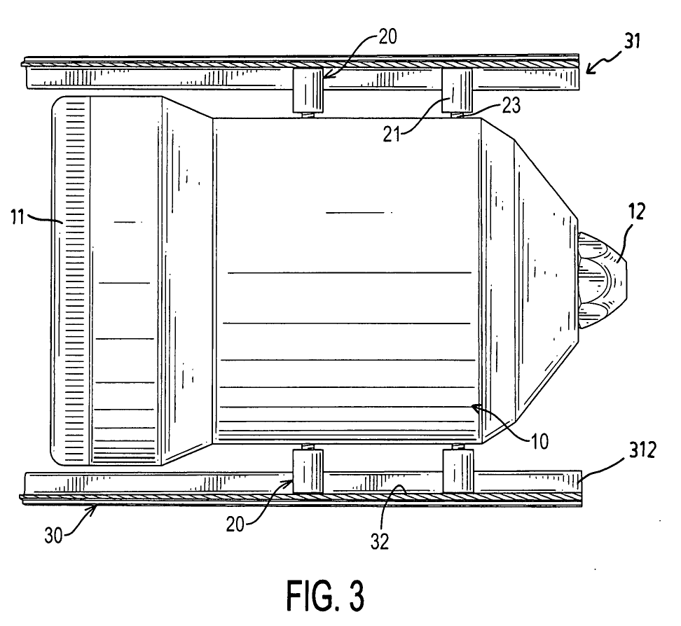

With reference to FIGS. 1, 2 and 3, a preferred embodiment of the monitoring camera with a shade in accordance with the present invention comprises a camera body (10), a shade (30) and four engaging elements (20).

The camera body (10) is a cylinder with a front end, a rear end, and a side surface. The camera body (10) has a lens (11) attached at the front end, a port (12) formed at the rear end and multiple threaded holes (14) defined on the side surface. Preferably, the multiple threaded holes (14) are arranged in two opposite longitudinal lines on the side surface of the camera body (10). In this embodiment, two of the threaded holes (14) are arranged in a line on corresponding sides of the body (10).

The shade (30) is a U-shaped shell with an inner surface, a front end, a rear end and two distal opposite edges. The shade (30) is made of resilient material such as plastic, aluminum or other stainless alloy. The shade (30) has two tracks (31) respectively and longitudinally formed on the inner surface at the two distal opposite edges. Each track (31) is composed of two erecting walls (312) and a sliding groove (32) defined between the two erecting walls (312).

Each engaging element (20) is a cylindrical post with an abutting end and a sliding end (21). The engaging element (20) has a threaded stub (23) and an optional bolt hole (22). The threaded stub (23) is formed on the abutting end to engage with the threaded hole (14) on the camera body (10). Thereby, the engaging element (20) is attached to the camera body (10) and can be screwed completely or incompletely to engage with the threaded hole (14) to adjust distance between the shade (30) and the camera body (10) especially when the shade (30) has different sizes. The optional bolt hole (22) is defined in the sliding end (21) and further description of the function will be described later.

When the camera body (10) assembles with the shade (30), the engaging elements (20) in two lines are respectively aligned with and received into the two sliding grooves (32) of the tracks (31). Then, the shade (30) is slidably mounted on the camera body (10). Because the engaging elements (20) protrude from the camera body (10) and are obviously seen, alignments of the engaging elements (20) to the tracks (31) are achieved easily. Preferably, the shade (30) has a distance between the two distal opposite edges slightly smaller than a total length composed of an outer diameter of the camera body (10) and two longitudinally axial lengths of the two corresponding opposite engaging elements (20). Therefore, the shade (30) constricts the engaging elements (20) on the camera body (10) to fasten itself on the camera body (10).

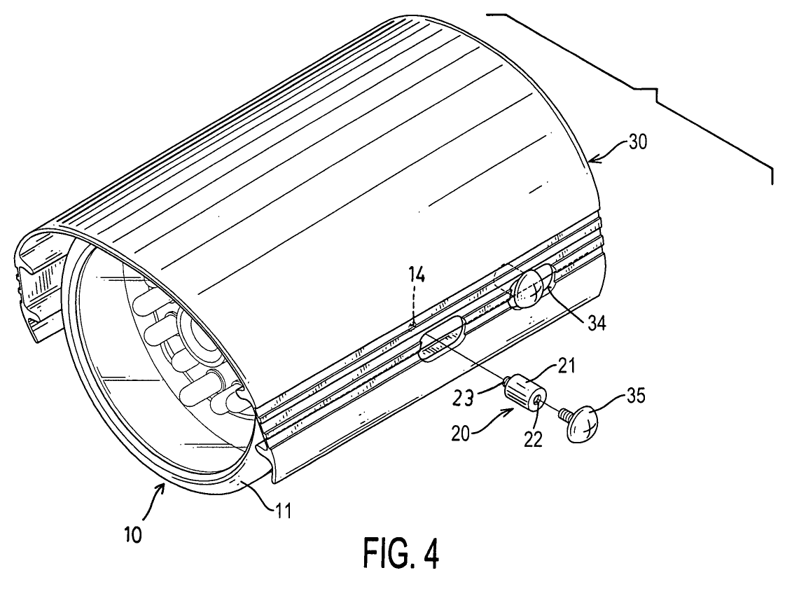

With reference to FIG. 4, another preferred embodiment of the monitoring camera with a shade in accordance with the present invention is shown, which further has multiple locking elements. Each locking element is a bolt (35) with an enlarged oval head and threaded rod. Correspondingly, the shade (30) further has multiple elongated holes (34) to correspondingly and operationally align with the engaging elements (20). Each elongated hole (34) has a width less than a diameter of the enlarged oval head of the bolt (35). Thereby, the threaded rod of the bolt (35) can penetrate the elongated hole (34) to screw to the bolt hole (22) on the engaging element (20) so as to secure the shade (30) on the camera body (10) by the engaging element (20).

According to the above description, the monitoring camera with a shade in the present invention has the following advantages:
1. The shade can be quickly and easily mounted on the camera body as the user can see the protruded engaging elements. Combination of the monitoring camera is no longer time-consuming.
2. The tracks in the monitoring camera of the present invention provide better positioning efficiency than the shallow grooves of the conventional one. Therefore, the shade does not easily slide out of the track and thus the shade is now kept stably sliding on the camera body.
3. The distance between the camera body and the shade can be adjusted by screwing the engaging elements into the threaded hole on the camera body to allow other shades of different sizes to be mounted on the camera body.

Although the invention has been explained in relation to its preferred embodiment, it is to be understood that many other possible modifications and variations can be made without departing from the spirit and scope of the invention as hereinafter claimed.

What is claimed is:

1. A monitoring camera with a shade comprising:
a camera body (10) being a cylinder with a front end, a rear end, a side surface and having multiple threaded holes (14) defined on the side surface;
a shade (30) slidably mounted on the camera body (10), being a U-shaped shell with an inner surface and two distal opposite edges and having multiple tracks (31) longitudinally formed on the inner surface of the shade (30); and
multiple engaging elements (20) slidably clamped between the shade (30) and the body (10), wherein each engaging element (20) is a cylindrical post with an abutting end and a sliding end (21) engaged with a corresponding one of the tracks (31) and having a threaded stub (23) formed on the abutting end to screw into a corresponding one of the threaded holes (23) on the camera body (10).

2. The monitoring camera as claimed in claim 1, wherein each track (31) is composed of two erecting walls (312) and a sliding groove (32) defined between the two erecting walls (312) to receive the sliding end (21) on the corresponding engaging element (20).

3. The monitoring camera as claimed in claim 2, wherein the multiple threaded holes (14) are arranged in two opposite longitudinal lines on the side surface of the camera body (10); and
two tracks (31) are respectively and longitudinally formed on the inner surface at the two distal opposite edges.

4. The monitoring camera as claimed in claim 1, wherein each engaging element further has a bolt hole (22) defined in the sliding end;
multiple locking elements are individually attached to the multiple engaging elements, each locking element is a bolt (35) with an enlarged oval head and threaded rod; and
the shade (30) further has multiple elongated holes (34) to correspondingly align with the engaging elements (20), each elongated hole (34) having a width less than a diameter of the enlarged oval head of the bolt (35).

5. The monitoring camera as claimed in claim 3, wherein each engaging element further has a bolt hole (22) defined in the sliding end;
multiple locking elements are individually attached to the multiple engaging elements, each locking element is a bolt (35) with an enlarged oval head and threaded rod; and
the shade (30) further has multiple elongated holes (34) to correspondingly align with the engaging elements (20), each elongated hole (34) having a width less than a diameter of the enlarged oval head of the bolt (35).
